(19) United States
(12) Patent Application Publication
(10) Pub. No.: US 2007/0031216 A1
(43) Pub. Date: Feb. 8, 2007

(54) Hay bale loading apparatus

(76) Inventor: Larry D. Wilson, Williston, ND (US)

Correspondence Address: NEUSTEL LAW OFFICES, LTD., 2534 SOUTH UNIVERSITY DRIVE, SUITE 4, FARGO, ND, 58103, US

(21) Appl. No.: 11/186,209

(22) Filed: Jul. 20, 2005

(51) Int. Cl. A01D 85/00

(52) U.S. Cl. 414/24.5

(57) ABSTRACT

A hay bale loading apparatus for effectively and efficiently loading and hauling hay bales. The hay bale loading apparatus includes a plurality of grasping arms, a first actuator, a second actuator and a frame that is attachable to a pickup truck. The grasping arms are movable by the first actuator such that the grasping arms can secure a hay bale. The second actuator is attached to the plurality of grasping arms and to the frame, wherein the second actuator causes the grasping arms to move the hay bale radially about the second actuator from the ground to the bed of a pickup truck.

### BACKGROUND OF THE INVENTION

1. Field of the Invention

The present invention relates generally to hay bale loading devices and more specifically it relates to a hay bale loading apparatus for effectively and efficiently loading and hauling hay bales.

2. Description of the Related Art

Any discussion of the prior art throughout the specification should in no way be considered as an admission that such prior art is widely known or forms part of common general knowledge in the field.

Hay bale loading devices have been in use for years. Typically, hay bale loading devices comprise a scoop loader attached to a tractor. The scoop loaders generally use a hydraulic means to lift a hay bale off of the ground and can hold the hay bale in a raised position while the tractor moves the hay bale.

Other hay bale loading devices require a hydraulic means to lift a hay bale onto the bed of a truck. These types of hay bale loaders generally grasp the hay bale and use hydraulic power to lift the bale onto the pickup truck bed.

In these respects, the hay bale loading apparatus according to the present invention substantially departs from the conventional concepts and designs of the prior art, and in so doing provides an apparatus primarily developed for the purpose of effectively and efficiently loading and hauling hay bales.

### BRIEF SUMMARY OF THE INVENTION

In view of the foregoing disadvantages inherent in the known types of hay bale loading devices now present in the prior art, the present invention provides a new hay bale loading apparatus construction wherein the same can be utilized for effectively and efficiently loading and hauling hay bales.

The general purpose of the present invention, which will be described subsequently in greater detail, is to provide a new hay bale loading apparatus that has many of the advantages of the hay bale loading devices mentioned heretofore and many novel features that result in a new hay bale loading apparatus which is not anticipated, rendered obvious, suggested, or even implied by any of the prior art hay bale loading devices, either alone or in any combination thereof.

To attain this, the present invention generally comprises a plurality of grasping arms, a first actuator, a second actuator and a frame that is attachable to a pickup truck. The grasping arms are movable by the first actuator such that the grasping arms can secure a hay bale. The second actuator is attached to the plurality of grasping arms and to the frame, wherein the second actuator causes the grasping arms to move the hay bale radially about the second actuator when the frame is attached to a pickup truck.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a hay bale loading apparatus that will overcome the shortcomings of the prior art devices.

A second object is to provide a hay bale loading apparatus for effectively and efficiently loading and hauling hay bales.

Another object is to provide a hay bale loading apparatus that is capable of loading a hay bale onto the bed of a pickup truck.

An additional object is to provide a hay bale loading apparatus that uses power from a twelve volt battery to move the hay bale.

A further object is to provide a hay bale loading apparatus that is removably attachable to the bed of a pickup.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2a is a side view of the present invention when attached to a pickup truck.

FIG. 2b is a side view of the present invention grasping a hay bale that is on the ground.

FIG. 3a is a side view of the present invention lifting a hay bale off of the ground.

FIG. 3b is a side view of the present invention where the hay bale has been lifted into the pickup truck bed.

FIG. 4 is a side view of the present invention not being attached to a pickup truck.

FIG. 5a is a top view of the present invention being attached to a pickup truck and having the grasping arms in the transportable position.

FIG. 5b is a top view of the present invention being attached to a pickup truck having the grasping arms in a grasping position prior to grasping the hay bale.

FIG. 6a is a top view of the present invention being attached to a pickup and having the first grasping arm in an extended position.

FIG. 6b is a top view of the present invention being attached to a pickup truck and having the first and second grasping arms in the extended position.

FIG. 7a is a top view of the present invention being attached to a pickup truck and having the securing member of the second grasping arm inserted into the hay bale.

FIG. 7b is a top view of the present invention being attached to a pickup truck and having the securing members of the first and second grasping arms inserted into the hay bale.

FIG. 8 is a top view of the present invention not attached to a pickup truck and having the securing members of the first and second grasping arms inserted into the hay bale.

### DETAILED DESCRIPTION OF THE INVENTION

A. Overview

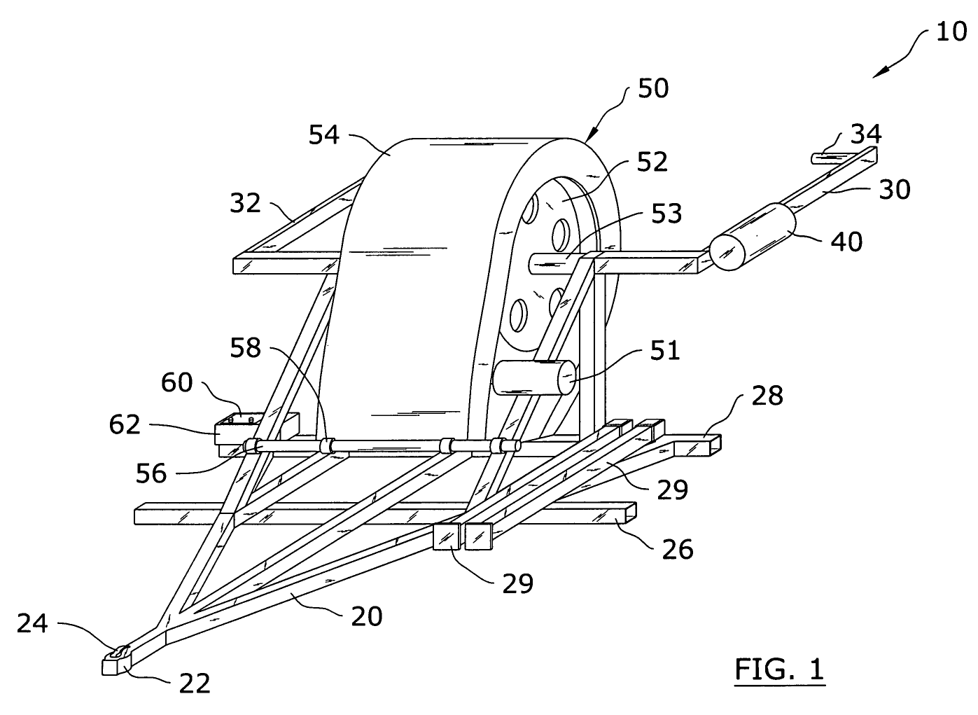

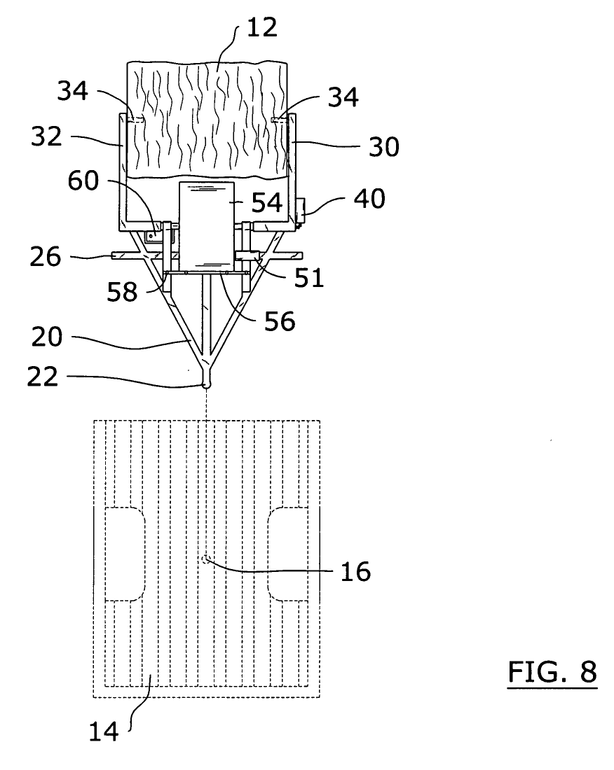

Turning now descriptively to the drawings, in which similar reference characters denote similar elements throughout the several views, FIGS. 1 through 8 illustrate a hay bale loading apparatus 10, which comprises a hay bale loading apparatus 10 for effectively and efficiently loading and hauling hay bales 12. The hay bale loading apparatus 10 includes a plurality of grasping arms 30, 32, a first actuator 40, a second actuator 50 and a frame 20 that is attachable to a pickup truck 14. The grasping arms 30, 32 are movable by the first actuator 40 such that the plurality of grasping arms 30, 32 can secure a hay bale 12. The second actuator 50 is attached to the plurality of grasping arms 30, 32 and to the frame 20, wherein the second actuator 50 causes the grasping arms 30, 32 to move the hay bale 12 radially about the second actuator 50 from the ground to the bed of a pickup truck 14.

B. Frame

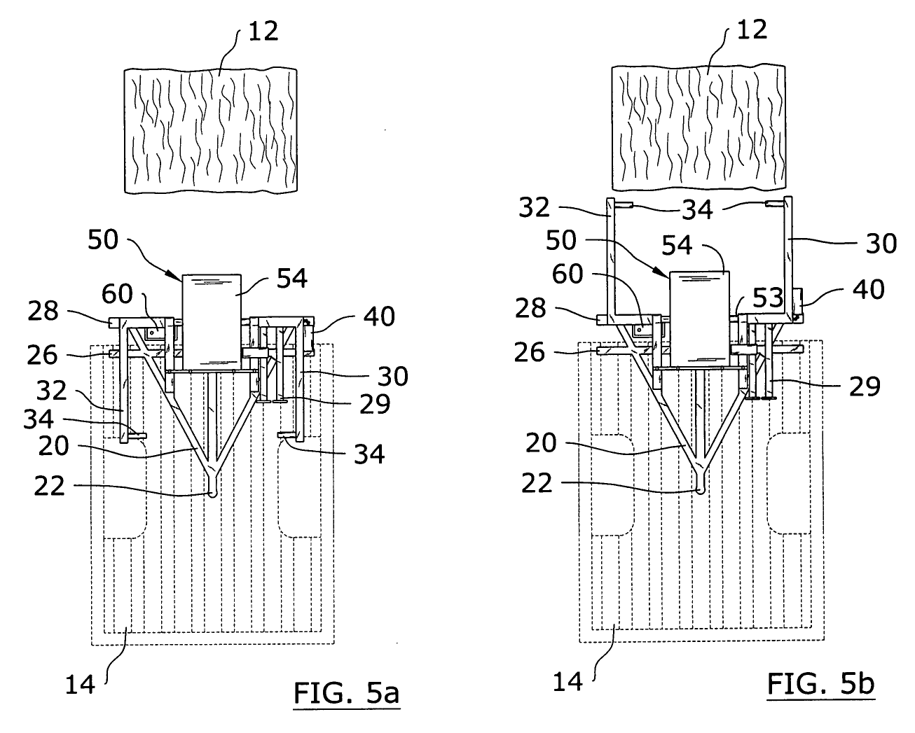

The frame 20 is preferably made of a rigid material that will not distort when supporting the weight of a hay bale 12. The frame 20 preferably includes a receiving member 22 that is attachable to a pickup hitch 16 as shown in FIGS. 5a through 8. The receiving member 22 is preferably attachable to a fifth-wheel pickup hitch 16 as shown in FIGS. 5a through 7b. The receiving member 22 can be secured on the pickup hitch 16 by positioning the receiving member 22 on the pickup hitch 16 and thereafter engaging the hitch lock 24.

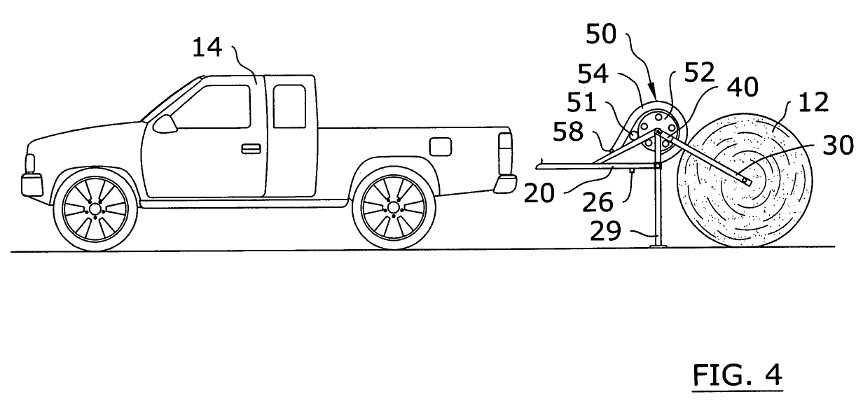

The frame 20 is preferably made of a substantially triangular structure wherein the sides of the frame 20 extend from the receiving member 22 to opposing ends of an end support member 28 as shown in FIGS. 1, 5a and 5b. The frame 20 also preferably includes a bar that extends substantially from the receiving member 22 between the sides of the frame 20 to substantially the center of the end support member 28 as illustrated in FIG. 1. A plurality of legs 29 are preferably attachable to the end support member 28 for supporting the frame 20 above the ground when the present invention has secured a hay bale 12 but is not attached to the pickup truck 14 as shown in FIG. 4.

The present invention also preferably includes a middle support member 26, which is positioned substantially in the middle of the receiving member 22 and the end support member 28 and is positioned substantially parallel to the end support member 28 as shown in FIGS. 5a through 8. The middle support member 26 allows the frame 20 to be positioned substantially parallel to the pickup bed when the hitch lock 24 of the receiving member 22 engages the pickup hitch 16 as shown in FIGS. 5a through 7b. Keeping the frame 20 substantially parallel to the pickup bed substantially evenly disperses the downward force made on the pickup bed made by frame 20 and a hay bale 12 resting on the pickup bed.

The second actuator 50 is also preferably attached to the frame 20 on the end support member 28 as shown in FIGS. 1 through 8. Loops 58 are preferably positioned on both the frame 20 and the gear cover 54 so that a securing rod 56 can be inserted through the loops 58, thereby securing the gear cover 54 to the frame 20 as shown in FIGS. 1 and 5a through 8. The battery case 62 and battery 60 are preferably positioned on the end support member 28 of the frame 20 as shown in FIGS. 1 and 5athrough 8.

C. Grasping Arms

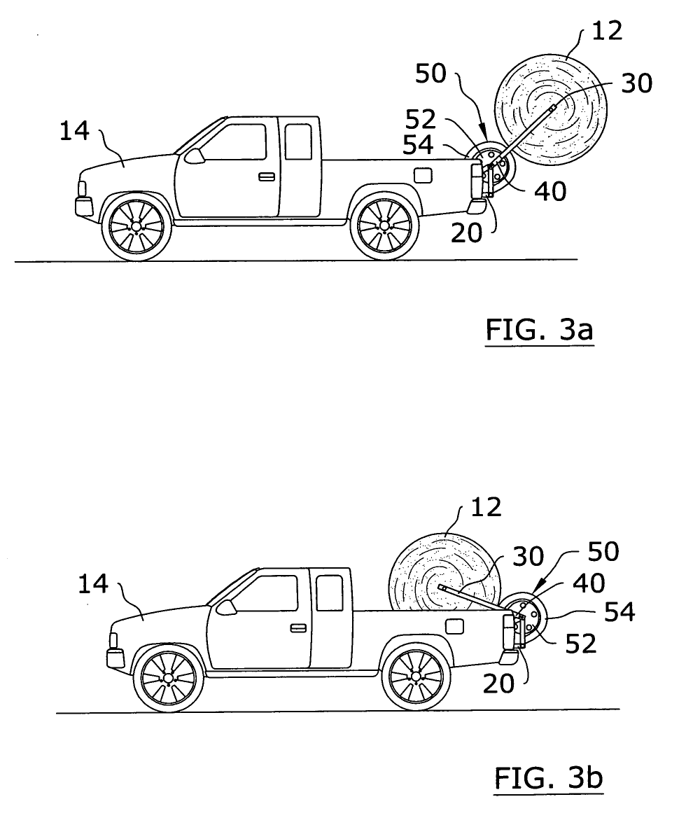

The present invention preferably includes a first grasping arm 30 and a second grasping arm 32 rotatably attached to opposite sides of the second actuator 50 as shown in FIGS. 1 and 5a through 8. The second actuator 50 rotates the first and second grasping arms 30, 32 in the same direction and at the same speed with respect to one another. The first and second grasping arms 30, 32 are preferably made of a rigid material that is able to withstand the weight of a hay bale 12 as shown in FIG. 3a.

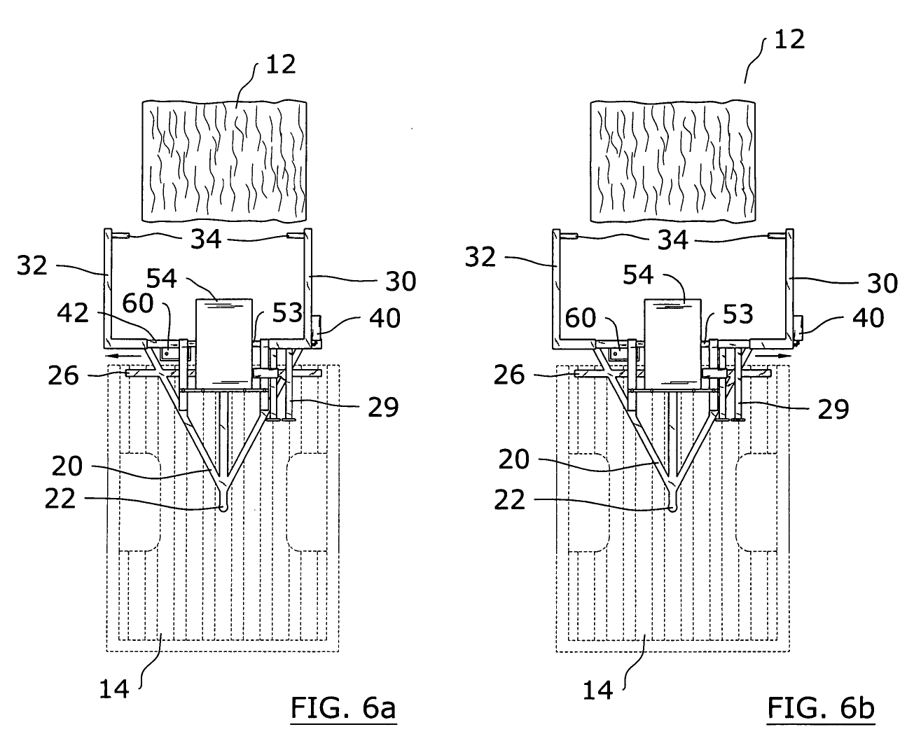

The first and second grasping arms 30, 32 preferably each include a securing member 34 on an end opposite the second actuator 50 as shown in FIGS. 5a through 8. Each securing member 34 also preferably protrudes substantially perpendicular to its respective grasping arm 30, 32 such that the securing members 34 are substantially co-planar as shown in FIGS. 5a through 6b.

The first actuator is preferably attached to the first grasping arm 30 as shown in FIGS. 1 and 4 through 8. The first and second grasping members 30, 32 each preferably pass through a section of the frame 20 to provide additional stability to the present invention as shown in FIGS. 1 and 4 through 8.

D. First Actuator

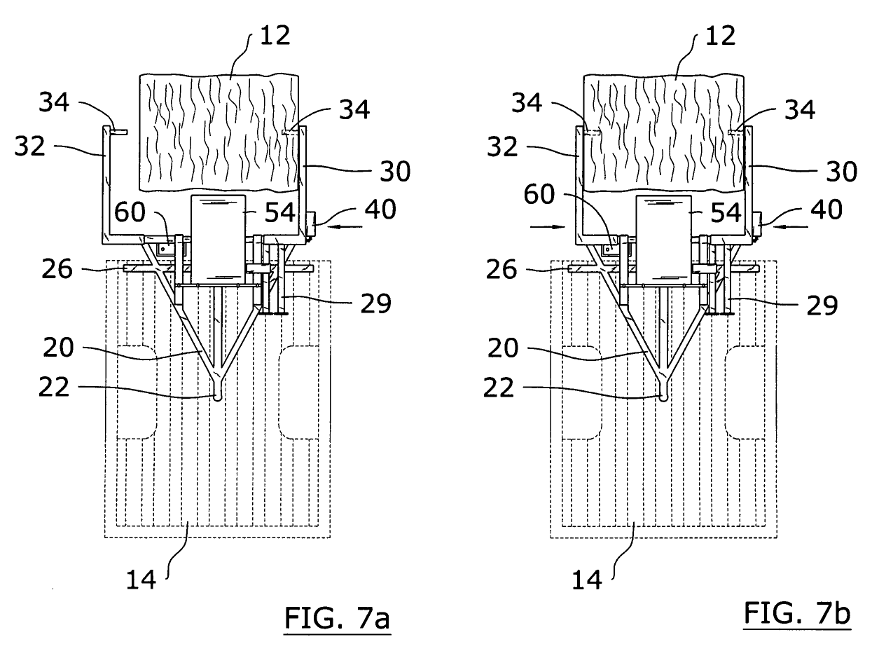

The first actuator 40 is preferably positioned on the first grasping arm 30 as shown in FIGS. 1 and 4 through 8. The first actuator 40 preferably moves the first and second grasping arms 30, 32 in a telescoping fashion either away from or toward the second actuator 50 about an extension member 42 as shown in FIGS. 6a through 7b.

By moving the first and second grasping arms 30, 32 in a telescoping fashion with respect to the extension members 42, the first and second grasping members 30, 32 are movable between a grasping position as shown in FIGS. 5b, 7b and 8 and an extended position as shown in FIG. 6b. The first and second grasping arms 30, 32 are preferably movable toward or away from the second actuator 50 in a consecutive fashion, as can be seen in FIGS. 6a through 7b.

E. Second Actuator

The second actuator 50 is preferably positioned near the center of the end support member 28 and on the end of the frame 20 opposite the receiving member 22 as shown in FIGS. 1 and 5a through 8. The second actuator 50 preferably is comprised of a motor 51, a lifting gear 52 and a gear cover 54 as shown in FIG. 1. The motor 51 preferably is in direct contact with the lifting gear 52 such that the motor 51 manipulates the lifting gear 52. The lifting gear 52 is preferably attached to a rotatable bar 53 as shown in FIG. 1.

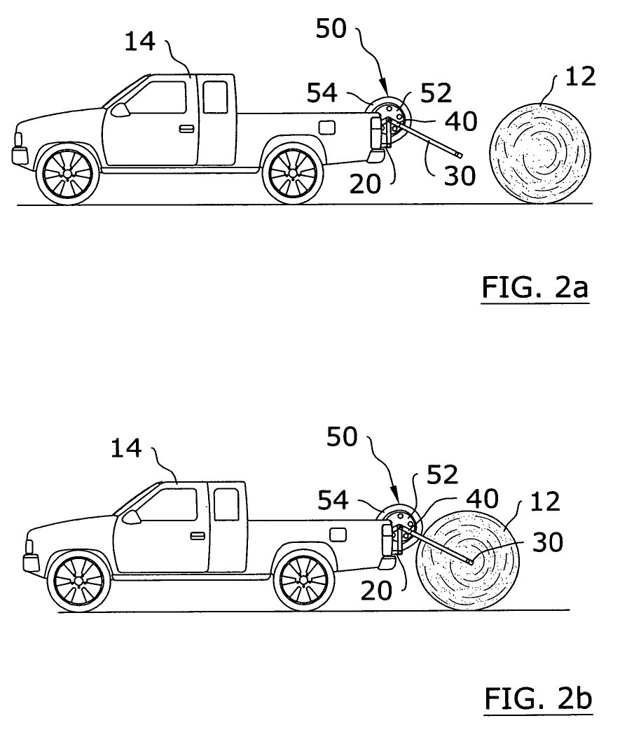

When the lifting gear 52 is set in motion by the motor 51, the lifting gear 52 manipulates the rotatable bar 53 which rotates the first and second grasping arms 30, 32 and their respective securing members 34 radially with respect to the lifting gear 52 as shown in FIGS. 2b, 3a and 3b. The motor 51 is preferably capable of manipulating the lifting gear 52 and rotatable bar 53 either clockwise or counter-clockwise whereby a hay bale 12 may be lifted from the ground to the pickup bed or from the pickup bed to the ground as illustrated between the positions shown in FIGS. 2b, 3a and 3b. The grasping arms 30, 32 can also be manipulated into a transportable position as shown in FIG. 5a, whereby the present invention is substantially housed within the pickup bed for transportation purposes, whether the grasping arms 30, 32 are holding a hay bale 12 or not.

The lifting gear 52 preferably includes a gear cover 54 to shield users from the moving parts of the motor 51 and the lifting gear 52 as shown in FIG. 1. The gear cover 54 is preferably securable to the frame 20 by the securing rod 56 and loops 58 as shown in FIGS. 1 and 5a through 8. There is preferably a plurality of loops 58 positioned on the frame 20 and at least one loop 58 positioned on the gear cover 54, wherein the loops 58 are aligned with one another when the gear cover 54 is covering the lifting gear 52 as shown in FIGS. 1 and 5a through 8. The loops 58 are preferably able to receive a securing rod 56 when the loops 58 are aligned as shown in FIGS. 1 and 5a through 8.

The securing rod 56 is insertable through the loops 58 when they are substantially aligned, thereby securing the gear cover 54 in a position that covers outer edges of the lifting gear 52 as shown in FIGS. 1 and 5a through 8. Removing the securing rod 56 would allow removal of the gear cover 54 for inspection or repair of portions of the present invention otherwise covered by the gear cover 54.

F. Battery

The battery 60 is preferably a twelve volt battery. The battery 60 is preferably housed in a battery case 62 that is positionable near an end of the end support member 28 as shown in FIGS. 1 and 5a through 8. The battery 60 provides power to the first and second actuators 40, 50 to move a hay bale 12 between the ground as illustrated in FIG. 2a and the pickup bed as shown in FIG. 3b.

G. Operation of Invention

In use, the receiving member 22 is preferably attached to a pickup hitch 16 as shown in FIGS. 5a through 7b. The second actuator 50 is activated and the first and second grasping arms 30, 32 are preferably rotated from their transportable position, as shown in FIG. 5a to their grasping position as shown in FIG. 5b. The first actuator 40 is activated and the first and second grasping arms 30, 32 are preferably each actuated away from each other in a consecutive, telescoping fashion from their grasping position to their extended position as shown in FIG. 6b. The pickup truck 14 is then preferably driven in reverse to a point where the securing members 34 of each of the first and second grasping arms 30, 32 are preferably adjacent to the middle of the hay bale 12 as shown in FIG. 2b.

When the securing members 34 are positioned substantially near the middle of the hay bale 12, the first actuator 40 is activated, preferably causing the first grasping arm 30 to move toward the hay bale 12, thereby inserting the securing member into the middle of the hay bale 12 as shown in FIG. 7a. When the first grasping arm 30 has inserted its securing member 34 into the hay bale 12, the first actuator 40 then preferably causes the second grasping arm 32 to be actuated toward the hay bale 12 as shown in FIG. 7b. It can be appreciated that the second grasping arm 32 is capable of moving toward the hay bale 12 before the first grasping arm 30, but that generally only one grasping arm 30, 32 moves at one time while the first actuator 40 is activated.

If the user wishes to remove the present invention from their pickup truck 14, the user would remove the legs 29 from the frame 20. The user then attaches the legs 29 to the end support member 28 of the frame 20 so that the legs 29 support the present invention as shown in FIG. 4. When the user wishes to reattach the present invention to the pickup truck 14, the user drives the pickup truck 14 in reverse to a position where the receiving member 22 of the frame 20 is attachable to the pickup hitch 16 via the hitch lock 24. The user then removes the legs 29, which is illustrated in FIG. 2b.

Once the securing members 34 of both the first and second grasping arms 30, 32 are inserted within the hay bale 12, the motor 51 of the second actuator 50 causes the lifting gear 52 to rotate, thereby rotating the rotatable bar 53. The rotatable bar 53 is rotated such that the hay bale 12 is picked up off the ground by the first and second grasping arms 30, 32 as shown in FIG. 3a. The lifting gear 52 continues to rotate the rotatable bar 53 causing the first and second grasping arms 30, 32 to move the hay bale 12 radially about the lifting gear 52 until the hay bale 12 is set down on the bed of the pickup truck 14 as shown in FIG. 3b. The user is then able to transport the hay bale 12 using a pickup truck 14 rather than using a tractor or other traditional means of transporting a hay bale 12.

The user may employ the opposite steps outlined above and the present invention will move the hay bale 12 from the bed of the pickup truck 14 as shown in FIG. 3b radially about the lifting gear 52 to the ground as shown in FIG. 2a.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A hay bale loading apparatus, comprising:
a plurality of grasping arms;
a first actuator;
a second actuator; and
a frame attachable to a pickup truck;
wherein said plurality of grasping arms are movable by said first actuator such that a hay bale is securable between said grasping arms;
wherein said second actuator is attached to said plurality of grasping arms and to said frame and said second actuator causes said plurality of grasping arms to move the hay bale radially about said second actuator from the ground to the bed of a pickup truck.

2. The hay bale loading apparatus of claim 1, wherein said plurality of grasping arms each have a securing member.

3. The hay bale loading apparatus of claim 2, wherein each said securing member is positioned on an end of each of said plurality of grasping arms opposite said second actuator.

4. The hay bale loading apparatus of claim 1, wherein said frame is attachable to a pickup truck hitch.

5. The hay bale loading apparatus of claim 1, wherein said frame includes a plurality of legs.

6. The hay bale loading apparatus of claim 5, wherein said plurality of legs are attachable to an end of said frame opposite said receiving member and extend between said frame and the ground.

7. The hay bale loading apparatus of claim 1, wherein said first actuator is an electric motor.

8. The hay bale loading apparatus of claim 1, wherein said second actuator is a gear driven by an electric motor.

9. The hay bale loading apparatus of claim 7, wherein said second actuator is a gear driven by an electric motor.

10. The hay bale loading apparatus of claim 8, wherein said gear is substantially radially covered by a gear cover.

11. The hay bale loading apparatus of claim 9, wherein said gear is substantially radially covered by a gear cover.

12. The hay bale loading apparatus of claim 1, wherein said first actuator is powered by a 12 volt battery.

13. The hay bale loading apparatus of claim 7, wherein said first actuator is powered by a 12 volt battery.

14. The hay bale loading apparatus of claim 1, wherein said second actuator is powered by a 12 volt battery.

15. The hay bale loading apparatus of claim 9, wherein said second actuator is powered by a 12 volt battery.

16. A hay bale loading apparatus, comprising:
a plurality of grasping arms;
a first actuator;
a second actuator;
a frame wherein said frame is attachable to a pickup truck;
wherein said plurality of grasping arms are movable by said first actuator such that a hay bale is securable between said grasping arms;
wherein said second actuator is attached to said plurality of grasping arms and to said frame and said second actuator causes said plurality of grasping arms to move the hay bale radially about said second actuator from the ground to the bed of a pickup truck;
wherein said plurality of grasping arms each have a securing member;
wherein each said securing member is positioned on an end of each of said plurality of grasping arms opposite said second actuator;
wherein each said securing member is substantially perpendicular to said plurality of grasping arms;
wherein said frame is attachable to a pickup truck hitch;
a plurality of legs;
wherein said plurality of legs are attachable to an end of said frame opposite said receiving member and extend between said frame and the ground;
an electric motor; and
wherein said first actuator is driven by said electric motor;
wherein said second actuator is a gear driven by an electric motor;
wherein said gear is substantially radially covered by a gear cover;
a 12 volt battery;
wherein said first actuator is powered by said 12 volt battery; and
wherein said second actuator is powered by said 12 volt battery.
